(19) United States
(12) Patent Application Publication
(10) Pub. No.: US 2021/0034946 A1
(43) Pub. Date: Feb. 4, 2021

(54) RECOGNIZING PROBLEMS IN PRODUCTIVITY FLOW FOR PRODUCTIVITY APPLICATIONS

(71) Applicant: Microsoft Technology Licensing, LLC, Redmond, WA (US)

(72) Inventors: Madeline Schuster KLEINER, Mercer Island, WA (US); Priyanka Subhash KULKARNI, Redmond, WA (US); Jignesh SHAH, Redmond, WA (US); Curtis Dean ANDERSON, Kent, WA (US); Bernhard Sebastian Johannes KOHLMEIER, Seattle, WA (US)

(21) Appl. No.: 16/530,939

(22) Filed: Aug. 2, 2019

(51) Int. Cl. G06N 3/04; G06F 9/54; G06N 3/08

(52) U.S. Cl. CPC G06N 3/04; G06N 3/08; G06F 9/54

(57) ABSTRACT

Recognizing problems in productivity flow for productivity applications can be accomplished by receiving a user profile and actions for a timeframe, where each action comprises an activity and timing; and identifying a grammar that captures action semantics and sequences in which they are executed that is similar to at least the actions for the timeframe, where the grammar corresponds to a help case. When the grammar is identified, corresponding help content for the help case can be retrieved and provided to the user.

### BACKGROUND

Productivity applications enable users to get their work done and accomplish their tasks. In general, productivity applications provide tools and platforms to author and consume content in electronic form. Examples of productivity applications include, but are not limited to word processing applications, notebook applications, presentation applications, spreadsheet applications, and communication applications (e.g., email applications and messaging applications).

While working within a product such as a productivity application running on a computer system, a user may experience difficulty in completing a task and desire assistance. Currently, a user may have to interrupt their task to search for a solution from a number of channels. Sometimes, the user may not realize that they are not using the right tools or features to complete a task or may not realize that they are not following the appropriate procedure required for the task—whether within a single application or across a number of productivity applications. For example, a user may be attempting a mail merge in MICROSOFT WORD, which involves multiple MICROSOFT OFFICE applications. When the user gets stuck, she has a few options to get unblocked. She can peck around the application to find the right buttons, go to the web and search for help with her task, go to a search experience at the top of the app and express her intent, go to Help in the application or on the web to find assistive content, or even take actions outside of the machine such as phoning a friend or asking a coworker or contacting customer support.

### BRIEF SUMMARY

Systems and techniques for recognizing problems in productivity flow for productivity applications are provided. Users may perform a number of tasks within a productivity application—and may even interact with other applications outside of the productivity application in order to achieve a desired outcome through performing the tasks. Sometimes, the user may not be certain how to achieve the desired outcome within the productivity application or may not realize that they are not following the standard operating procedures for their task (such as preferred by their employer). The described systems and methods can recognize and predict a problem in the productivity flow of such users and provide help content to direct the user to the sequence of activities that can achieve the desired outcome including accomplishing a certain task.

A computer-implemented method of recognizing and predicting problems in productivity flow for productivity applications can include: receiving a user profile and actions for a timeframe, each action comprising an activity and timing; identifying a grammar that captures action semantics and sequences in which they are executed that is similar to at least the actions for the timeframe, the grammar corresponding to a help case; and when the grammar is identified, retrieving corresponding help content for the help case and providing the corresponding help content.

A system that can recognize and predict problems in productivity flow for productivity applications can include a machine learning system such as a neural network or other machine learning system; one or more hardware processors; one or more storage media; and instructions stored on the one or more storage media that when executed by the one or more hardware processors direct the system to at least receive a user profile and actions for a timeframe, each action comprising an activity and timing; identify a grammar that captures action semantics and sequences in which they are executed that is similar to at least the actions for the timeframe using the machine learning system, the grammar corresponding to a help case; and when the grammar is identified, retrieve corresponding help content for the help case and providing the corresponding help content.

In some cases, the help content would only appear in an application receiving the corresponding help content if the application was confident that the user is in need of assistance (e.g., based on a confidence score or other indicator that may be provided by the system based on whether the grammar is identified), and the application would only show the help content that is predicted to help unblock the user in her task (e.g., as indicated by a confidence score that may be provided with the corresponding help content). In some cases, if the system determines that there is insufficient confidence that the user is in need of assistance or that there is insufficient confidence that there exists help content that could help unblock the user in her task, the system may provide no help content. For example, when there is no grammar identified, the system can either provide no content or indicate that a help case was not identified (and optionally provide other types of content). As another example, when there is a grammar identified (e.g., indicating that it is predicted that the user will fail to achieve a desired outcome) but there is insufficient confidence that there exists help content, the system can provide a “rewind option” that would bring the user/application back to a state before incorrect actions were taken.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a system for recognizing and predicting problems in a productivity flow.

FIG. 2 illustrates an example method for recognizing, predicting, and assisting with problems in a productivity flow.

FIG. 3 illustrates an example operating environment for recognizing problems in a productivity flow.

FIGS. 4A and 4B illustrate example application search interfaces with help content provided as part of a search experience.

FIG. 5 illustrates an example path correction flow including an application search experience.

FIG. 6A illustrates examples command sequences that can indicate a help case or predict failure.

FIG. 6B illustrates an example neural model from some training data with respect to MICROSOFT WORD.

FIG. 7 illustrates components of a computing device through which a user may need assistance with their productivity flow.

FIG. 8 illustrates components of a system through which to recognize problems in a productivity flow.

### DETAILED DESCRIPTION

Systems and techniques for recognizing problems in productivity flow for productivity applications are provided.

Users may perform a number of tasks within a productivity application—and may even interact with other applications outside of the productivity application in order to achieve a desired outcome through performing the tasks. Sometimes, the user may not be certain how to achieve the desired outcome within the productivity application or may not realize that they are not following the standard operating procedures for their task (such as preferred by their employer). The described systems and methods can recognize and predict a problem in the productivity flow of such users and provide help content to direct the user to the sequence of activities that can achieve the desired outcome including accomplishing a certain task.

User actions, including the combination of an activity and the timing, are used to determine whether the user is stuck in attempting to accomplish a task in a productivity application and to predict what help content could best unblock the user. An activity refers to the command or interaction with an application, which may be the productivity application or some other application (e.g., any active application as identified by an operating system) that is or becomes active by the command or interaction. The timing refers to time information, which may be in the form of a date/time based from the system clock or a relative timing based on a start of a session of a productivity application. The combination of activity and timing (and optionally other information such as application information) is referred to as an action. A user profile can be obtained along with the actions to perform the problem recognition. The user profile can include a user identifier and information about the user such as geolocale (e.g., geographic location or region), application proficiency (e.g., level of expertise), commonly completed tasks, position (e.g., role), department, group, course (e.g., classroom, subject, or course identifier), and the like.

The help content includes, but is not limited to, help articles, instructional videos, GIFs, interactive walkthroughs, examples, action features (e.g., scheduling of a meeting), access to a gig economy, etc.

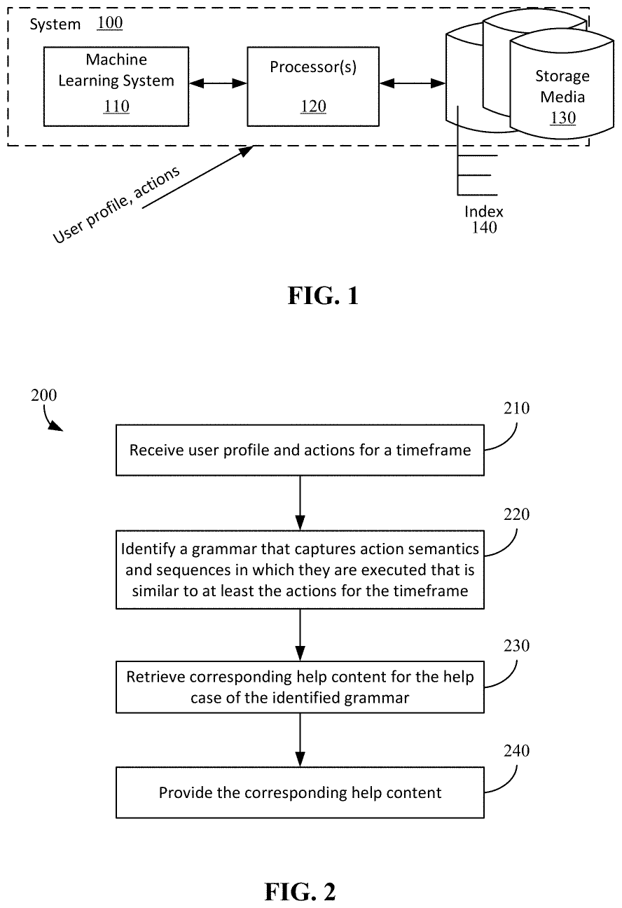

FIG. 1 illustrates a system for recognizing and predicting problems in a productivity flow; and FIG. 2 illustrates an example method for recognizing, predicting, and assisting with problems in a productivity flow.

Referring to FIG. 1, a system 100 for recognizing and predicting problems in a productivity flow can include a machine learning system 110, one or more hardware processors 120, and one or more storage media 130. Aspects of system 100 may be embodied as described with respect to system 800 of FIG. 8.

The one or more hardware processors 120 execute instructions, implementing aspects of method 200 of FIG. 2, stored on the one or more storage media 130 to recognize and predict problems in a productivity flow. For example, a user profile and actions for a timeframe can be received (210) at the system 100. Each action can include an activity and timing. This information can be processed and sent to the machine learning system 110.

The machine learning system 110 can include a neural network or other machine learning system. The machine learning system 110 can generate and update existing models, such as neural network models, through training and evaluation processes. When deployed, the model or models can be used to identify (220) a grammar that captures action semantics and sequences in which they are executed that is similar to at least the actions for the timeframe that was received by the system 100. In some cases, a rules-based system such as If This Then That (IFFT) services may be used to identify a grammar. The rules-based system may be used instead of or in addition to machine learning systems.

The similarity between the actions in the grammar to the actions for the timeframe enables sequences of activities that have a similar meaning or aspect to be used to identify whether the user may be encountering a problem. This feature allows for there to be different commands or even the commands in a different order—so long as the meaning has similarities.

In some cases, no grammar is identified that is similar to at least the actions for the timeframe and/or a grammar that is not indicative of a help case may be found to be similar. In some cases, the system determines that there is no grammar that is similar based on similarity scores. For example, the system can determine that no help case is identified with sufficient confidence based on the similarity scores of the grammars. “Sufficient confidence” refers to a threshold value that the system uses to determine whether a similarity score indicates a useful match. An indication that a help case was not identified may be provided by the system based on whether the grammar indicative of a help case is identified. This indicator may be a semantic indicator/event or a score/value.

When the grammar is identified, the system 100 can retrieve (230) corresponding help content for the help case and provide (240) the corresponding help content. The identification of the grammar, as well as the corresponding help content can involve confidence scores. The confidence scores can be provided with the corresponding help content so that an application receiving the help content can determine whether the user is in need of assistance and/or whether there is help content that is predicted to help unblock the user in her task. In some cases, a confidence score is provided with the corresponding help content.

In some cases, if the system determines that there is insufficient confidence that there exists help content that could help unblock the user in her task, the system may provide no help content and/or provide a confidence score with the content that the application receiving the content can use to make a determination as to whether to surface the help content. As another example, when there is a grammar identified (e.g., indicating that it is predicted that the user will fail to achieve a desired outcome) but there is insufficient confidence that there exists help content, the system can provide a “rewind option” that would bring the user/application back to a state before incorrect actions were taken.

The system 100 can manage the help content for the help cases. For example, an index 140 of help content can be maintained and updated by the system (and stored on one or more of the one or more storage media). The index can indicate location of the help content and a topic of the help content. In some cases, the help content can be determined from usage. The usage can be whether existing help content that was provided to a user was selected/viewed (or in some cases explicitly marked by the user as being helpful). In some cases, the usage can be from tracking user behavior (with permission from the user) and identifying the type of help content that the user seeks. The content determined from usage can be fed back to the index 140.

In some cases, an application programming interface can be provided for other applications to support the submission help content and optionally indicate the appropriate corresponding help cases or set of users. In some cases, the help content itself is not stored in a content resource associated with the system; rather, the location and topic are provided for the index.

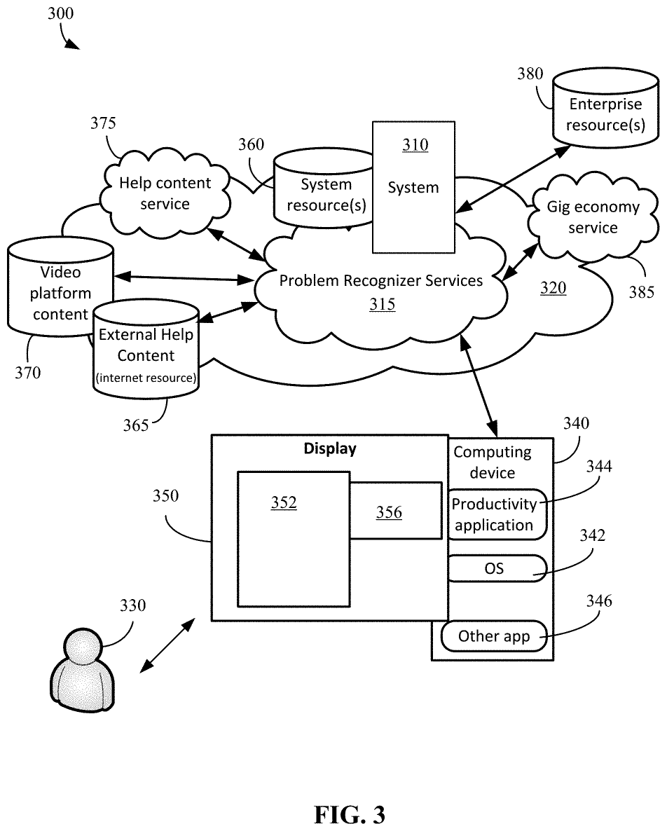

FIG. 3 illustrates an example operating environment for recognizing problems in a productivity flow. Referring to FIG. 3, the operating environment 300 can include a system 310 for recognizing problems in a productivity flow. System 310 can be embodied such as described with respect to system 100 of FIG. 1. The functionality of system 310 can be accessed via problem recognizer services 315 provided by the system 310.

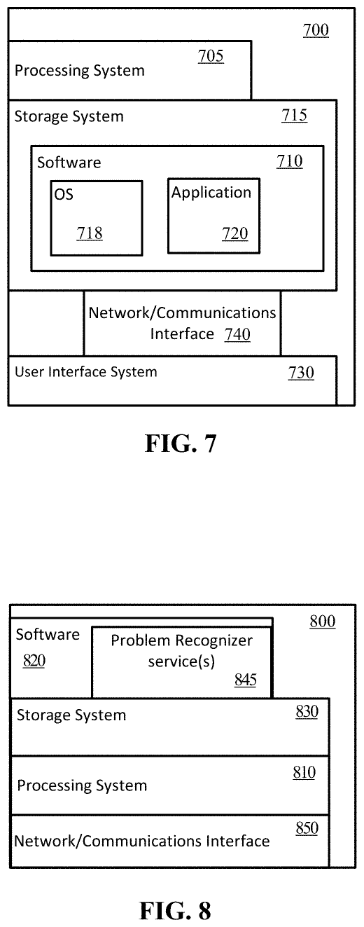

Here, a user 330 may be performing tasks on a computing device 340, which can be embodied as described with respect to system 700 of FIG. 7. Device 340 is configured to operate an operating system (OS) 342 and one or more application programs such as productivity application 344 and other application 346. User 330 may interact with productivity application 344 via the productivity application interface 352 rendered at the display 350 of the device 340. Interactions with the other application 346 can be made via the other application interface 356 rendered at the display 350. The productivity application 344 can receive information regarding the user's interactions with the other application 346 via capabilities of the operating system 343. These interactions (both with the productivity application and with the other application) can be communicated to system 310 (e.g., using services 315).

Services 315 support interoperable machine-to-machine interaction over network 320 and enables software (e.g., at system 310) to connect to other software applications (e.g., productivity application 344). Services 315 can provide a collection of technological standards and protocols (e.g., as part of application programming interfaces APIs). Communications between an application and services 315 may be via ubiquitous web protocols and data formats such as hypertext transfer protocol (HTTP), XML, JavaScript Object Notation (JSON), and SOAP (originally an acronym for simple object access protocol).

The network 320 can include, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

At the system 310, processes such as described with respect to method 200 of FIG. 2 can be carried out. For example, system 310 can identify a grammar that captures action semantics and sequences in which they are executed that is similar to at least the actions received from device 340 for a timeframe (e.g., operation 220); and can retrieve corresponding help content for the help case of the identified grammar (e.g., operation 230).

In some cases, help content is retrieved from a help content resource 360 associated with the system 310 (and provided) or a link is provided to content at the help content resource 360 associated with the system 310. In some cases, the help content is retrieved from an Internet resource (e.g., external help content resource 365) found as external help content across the Internet (and provided) or a link is provided to content at the Internet resource 365. In some cases, help content is retrieved from a video platform 370 (and provided) or a link is provided to content at the video platform 370. In some cases, help content can be obtained through use of a help content service 375. Help content service 375 may be used to access any type of help content and may include multiple different help content services. In yet other cases, help content can be retrieved from an enterprise resource 380 (and provided) or a link is provided to the content at the enterprise resource 380. The enterprise resource 380 may be managed by cloud services or be on-site for the enterprise. In some cases, help content can be obtained through the gig economy, for example via a gig economy service 385. The gig economy service 385 may be a service provided by any suitable gig economy application system that supports connecting people or things with an entity (e.g., a person or business) that has temporary use/engagement for that person or thing.

In various scenarios, any tagged content may be used as help content. In addition, the help content can be obtained from various sources including websites, a Support knowledge base, community forums, and product support resources.

The system 310 can index all of the help content. In addition, as users seek out help, that information can be fed back and added to the index.

It should be understood that the described problem recognition systems are suitable for any productivity application having desirable productivity flows, including platforms that track service requests and other platforms supporting a particular workflow or standard operating procedure.

As previously mentioned, a machine learning system can be part of a system for recognizing and predicting problems in a productivity flow. The machine learning system can train on and generate models that are then used to predict the appropriate help content. In some cases, command prediction can be provided as well.

In some cases, access to the help content can be provided through an application search interface. For example, a system for recognizing and predicting problems in a productivity flow can be triggered to perform operations when a user clicks into a search interface of the productivity application. The prior actions of the user (e.g., the activity and timing) can be provided to the described system and the help content, when identified, is returned for display as part of a search experience.

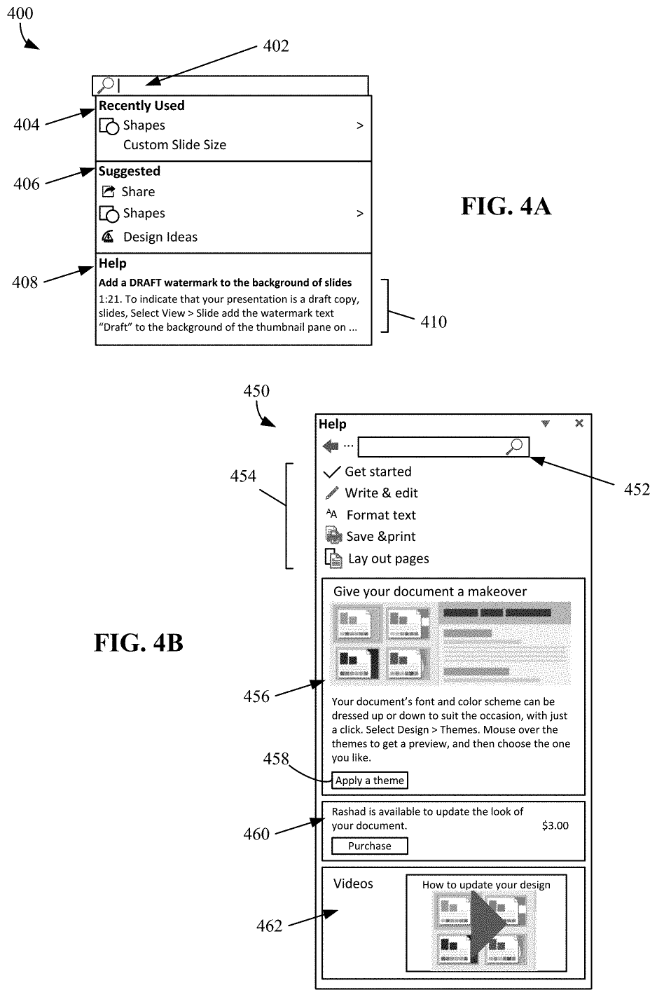

FIGS. 4A and 4B illustrate example application search interfaces with help content provided as part of a search experience.

The described systems and techniques enable a productivity application to detect the user's implicit need for assistance (e.g., that the user is stuck/blocked in her current task) and to proactively provide help content relevant to the goal the user is trying to achieve in the search experience without the user having to explicitly describe the task. The help content would only appear if the application was confident that the user is in need of assistance, and it would only show content that it predicts will help unblock the user in her task. As mentioned above, in some cases, the help content would only appear in an application receiving the corresponding help content if the application was confident that the user is in need of assistance (e.g., based on a confidence score or other indicator that may be provided by the system based on whether the grammar is identified), and the application would only show the help content that is predicted to help unblock the user in her task (e.g., as indicated by a confidence score that may be provided with the corresponding help content). In some cases, if the system determines that there is insufficient confidence that the user is in need of assistance or that there is insufficient confidence that there exists help content that could help unblock the user in her task, the system may provide no help content. For example, when there is no grammar identified, the system can either provide no content or indicate that a help case was not identified (and optionally provide other types of content). As another example, when there is a grammar identified (e.g., indicating that it is predicted that the user will fail to achieve a desired outcome) but there is insufficient confidence that there exists help content, the system can provide a “rewind option” that would bring the user/application back to a state before incorrect actions were taken.

Referring to FIG. 4A, a user may access predicted help content via the in-application search interface 400. Before the user starts typing in the search bar 400, there can be suggestions for the user to select. In the example shown in FIG. 4A, recently used commands 404 and suggested commands 406 are shown as part of the search experience. When the productivity application includes recognition and prediction of problems in productivity flow (e.g., via problem recognizer services), the search experience can include suggested help content 408. In the illustrated example, the help content 408 includes help articles—including preview 410 of a help article on adding a watermark to the background of slides, which would have been identified by the prior activities and timing of the user. As can be seen from the example, the help content does not have to be similar to the suggested commands, which in this case shows a suggested command to share, shapes, and design ideas, since the analysis for the help content suggestions is taking into consideration the actions as a whole as opposed to trying to identify the next likely command. This enables content on more than just a next likely action and is useful to address the task as a whole. Of course, help content may be provided on how to use the next likely command, depending on the models and the scenario. For example, there can be a model that is used to identify a next or suggested command and a model for recognizing help cases in a sequence of actions for a timeframe. Depending on the confidence values for the help cases, for example, if there is low confidence that there is a help case, the next or suggested command may be used instead.

Referring to FIG. 4B, a user may access predicted help content via a help interface or pane 450. In this example, a search bar 452 and a number of topics 454 may be available for the user to select. The predicted help content may include not just articles, like the article 456 for “giving the document a makeover,” but also commands (e.g., “apply a theme” command 458) that may initiate an action with respect to the application. In either type of interface (e.g., 400 or 450) the help content can include other forms of help besides articles. For example, a support call could be made to another person (which may be identified by their relationship to the user in an organization or identified by role position in the user's organization or another organization), a gig-economy portal can be provided to enable a user to purchase help, and videos can be provided. As shown in the pane 450, an expert is available to have perform the task for the user for a fee as indicated in the gig-economy portal 460. The help content also includes video content 462

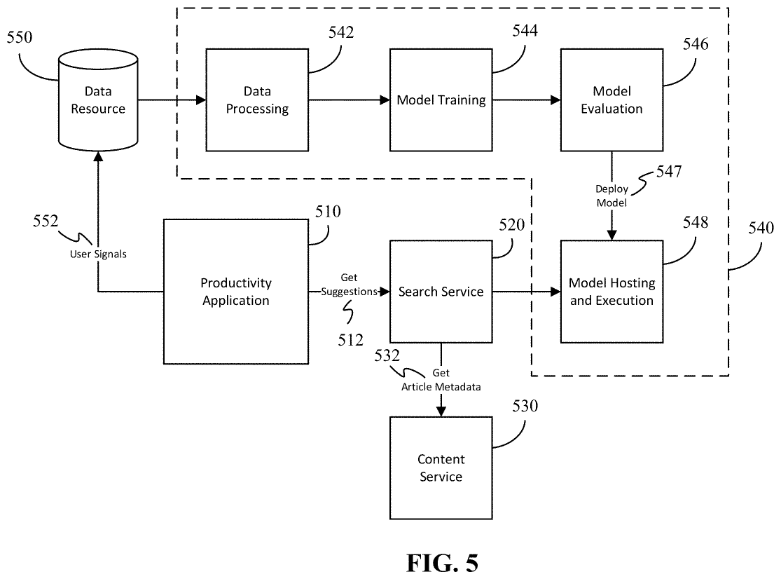

FIG. 5 illustrates an example path correction flow including an application search experience. Referring to FIG. 5, a productivity application 510 can include an in-application search experience feature that gets help suggestions (512) using a search service 520. The search service 520 can be the gateway to a content service 530 that can be used to get article and other content metadata (532) and a machine learning system 540 that can be used to recognize and predict problems in a productivity flow and facilitate suggestions of help content. To support the recognition and prediction of problems in a productivity flow of productivity application 510, user signals (552) can be collected (when given permission by user) and stored in a data resource 550. The information stored in the data resource 550 can be used by the machine learning system 540, which includes a data processing component 542, model training component 544, and model evaluation component 546. New models can continually be generated and updated as new data is received. In addition, for some models, the type of data and the type of help content can be specific to a particular enterprise; while for other models, more global models are generated. Once the models are evaluated at the model evaluation component 546, the models can be deployed (547) to the model hosting and execution component 548, which is used by the search service 520 to support the recognizing and predicting of problems in a user's productivity flow.

Accordingly, when triggered, the in-application search experience communicates the user identifier and actions for a timeframe to the search service 520, which uses the content service 530 and the machine learning system 540 (particularly the model hosting and execution component 548) to obtain predicted help content.

The system can be extensible and provide inputs to indicate the types of help offerings that can be provided, including articles, answers, tickets, etc. For example, the content service 530 can support the inclusion and management of help content.

The described systems and techniques enable course correction for users that may be taking steps that will get them stuck. The help content is more than just predicting a next command, but instead can present information on how to accomplish a task, achieve a desired outcome, or properly complete the steps being taken by the user. It is possible to just use a user's command history and the timing of those commands to predict the assistance that may be needed.

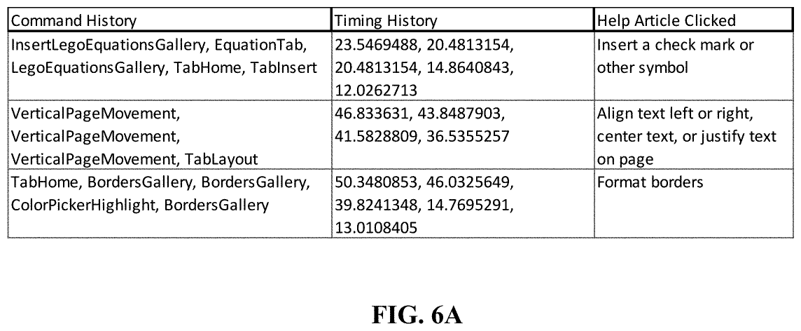

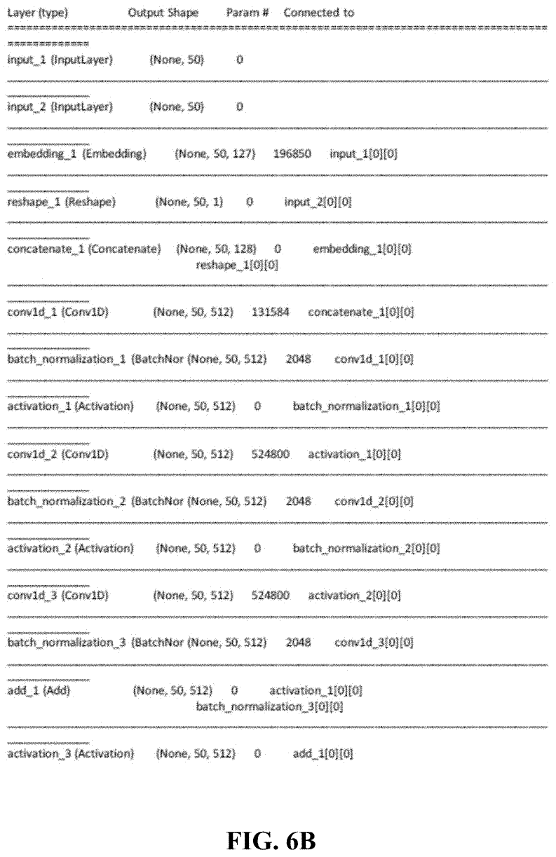

FIG. 6A illustrates examples command sequences that can indicate a help case or predict failure. As illustrated in FIG. 6A, a set of activities (e.g., the command history) and their corresponding timings (e.g., the timing history) have resulted in certain help content being accessed.

The command history and timing history can be considered a type of grammar for a help case that has an associated help content. In some cases, where there is insufficient confidence that a command history and timing history results in a help case, then a next command prediction model may be used and help content with article information having semantic similarity with the predicted command information can be provided as the help content.

In some cases, the models can take into consideration proficiency levels of the users—such that certain models are trained on command sequences indicating a help case that were performed by users grouped according to proficiency level or some other category for grouping.

In some cases, proficiency levels of the users can also be factored in when determining whether to show a Help article for a fall-back case of defaulting to the predicted commands and their semantic similarity with a help article. For example, if a novice MICROSOFT EXCEL user is trying to do a Vlookup, but has not exhibited a bad grammar (as identified by the system), the system may still show a Help article for Vlookup for that user but not a more proficient user. The system or the application may make the determination of showing the help content regardless of the failure to identify a grammar indicating a help case based on the user's usage history over time, the user's proficiency level, as well as the relative difficulty of particular commands.

Mappings between help cases and help content may be accomplished using cosine similarity/semantic similarity between command information (from the actions taken by a user) and help content information. For example, command information may include details such as a name and certain text related to its description or use tip. Help content such as from an article can have article information including name, content, and associated search phrases (e.g., what might be associated with the article from a search engine). The information from the commands and the articles can be analyzed for semantic similarity.

FIG. 6B illustrates an example neural model from some training data with respect to MICROSOFT WORD. Referring to FIG. 6B, a grammar element can be seen embedded in the “embedding” element.

FIG. 7 illustrates components of a computing device through which a user may need assistance with their productivity flow; and FIG. 8 illustrates components of a system through which to recognize problems in a productivity flow.

Referring to FIG. 7, system 700 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, or a smart television. Accordingly, more or fewer elements described with respect to system 700 may be incorporated to implement a particular computing device.

System 700 includes a processing system 705 of one or more processors to transform or manipulate data according to the instructions of software 710 stored on a storage system 715. Examples of processors of the processing system 705 include general purpose central processing units, application specific processors, and logic devices, as well as any other type of processing device, combinations, or variations thereof. The processing system 705 may be, or is included in, a system-on-chip (SoC) along with one or more other components such as network connectivity components, sensors, video display components.

The software 710 can include an operating system 718 and application programs such as productivity application 720 that can communicate with system 100 of FIG. 1 and/or problem recognizer services 315 of FIG. 3 as described herein. Application 720 can be any suitable productivity application.

Device operating systems generally control and coordinate the functions of the various components in the computing device, providing an easier way for applications to connect with lower level interfaces like the networking interface (e.g., interface 740). In addition, the OS 718 can provide information regarding interactions with the various application programs.

Storage system 715 may comprise any computer readable storage media readable by the processing system 705 and capable of storing software 710 including the application 720. Examples of storage media of storage system 715 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium (or any storage media described herein) a transitory propagated signal.

Storage system 715 may be implemented as a single storage device but may also be implemented across multiple storage devices or sub-systems co-located or distributed relative to each other. Storage system 715 may include additional elements, such as a controller, capable of communicating with processing system 705.

The system can further include user interface system 730, which may include input/output (I/O) devices and components that enable communication between a user and the system 700. User interface system 730 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 730 may also include output devices such as display screen(s), speakers, haptic devices for tactile feedback, and other types of output devices. In certain cases, the input and output devices may be combined in a single device, such as a touchscreen, or touch-sensitive, display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology.

Visual output, including that described with respect to FIGS. 4A and 4B, may be depicted on the display (not shown) in myriad ways, presenting graphical user interface elements, text, images, video, notifications, virtual buttons, virtual keyboards, or any other type of information capable of being depicted in visual form.

The user interface system 730 may also include user interface software and associated software (e.g., for graphics chips and input devices) executed by the OS in support of the various user input and output devices. The associated software assists the OS in communicating user interface hardware events to application programs using defined mechanisms. The user interface system 730 including user interface software may support a graphical user interface, a natural user interface, or any other type of user interface.

Network interface 740 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Certain aspects described herein, such as those carried out by the System for recognizing and predicting problems in a productivity flow described herein may be performed on a system such as shown in FIG. 8. Referring to FIG. 8, system 800 may be implemented within a single computing device or distributed across multiple computing devices or sub-systems that cooperate in executing program instructions. The system 800 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 800 can include a processing system 810, which may include one or more hardware processors and/or other circuitry that retrieves and executes software 820 from storage system 830. Processing system 810 may be implemented within a single processing device but may also be distributed across multiple processing devices or sub-systems that cooperate in executing program instructions.

Storage system(s) 830 can include one or more storage media that can be any computer readable storage media readable by processing system 810 and capable of storing software 820. Storage system 830 may be implemented as a single storage device but may also be implemented across multiple storage devices or sub-systems co-located or distributed relative to each other. Storage system 830 may include additional elements, such as a controller, capable of communicating with processing system 810.

Software 820, including that supporting the problem recognizer service(s) 845 (and processes 200 as described with respect to FIG. 2), may be implemented in program instructions and among other functions may, when executed by system 800 in general or processing system 810 in particular, direct the system 800 or processing system 810 to operate as described herein.

In embodiments where the system 800 includes multiple computing devices, the system can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A network/communication interface 850 may be included, providing communication connections and devices that allow for communication between system 800 and other computing systems (not shown) over a communication network or collection of networks (not shown) or the air.

Certain techniques set forth herein with respect to the application and/or the Secure Transaction service may be described in the general context of computer-executable instructions, such as program modules, executed by one or more computing devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A computer-implemented method of recognizing and predicting problems in productivity flow for productivity applications, comprising:
receiving a user profile and actions for a timeframe, each action comprising an activity and timing;
identifying a grammar that captures action semantics and sequences in which they are executed that is similar to at least the actions for the timeframe, the grammar corresponding to a help case; and
when the grammar is identified, retrieving corresponding help content for the help case and providing the corresponding help content.

2. The method of claim 1, wherein when the grammar corresponding to the help case is not identified with a sufficient confidence, the method further comprising providing an indication that a help case was not identified.

3. The method of claim 1, wherein the activity is with respect to any active application as identified by an operating system.

4. The method of claim 1, wherein identifying the grammar that captures action semantics and sequences in which they are executed that is similar comprises using a neural network model.

5. The method of claim 1, wherein a confidence score is provided with the corresponding help content.

6. The method of claim 1, further comprising managing the help content for help cases.

7. The method of claim 6, wherein one or more help content of the help content for help cases is determined from usage and stored in an index that at least indicates location of the help content and a topic of the help content.

8. The method of claim 6, wherein help content is received via an application programming interface supporting adding or updating help content for a particular help case or set of users.

9. The method of claim 6, wherein the help content is retrieved from a help content resource, an Internet resource, a video platform with tagged content, a gig economy service, or a service providing help content.

10. The method of claim 1, wherein the user profile includes a user identifier and information about the user with respect to level of expertise, position, department, group, course, or geographic location or region.

11. A system for recognizing and predicting problems in productivity flow for productivity applications, comprising:
a machine learning system;
one or more hardware processors;
one or more storage media; and
instructions stored on the one or more storage media that when executed by the one or more hardware processors direct the system to at least:
receive a user profile and actions for a timeframe, each action comprising an activity and timing;
identify a grammar that captures action semantics and sequences in which they are executed that is similar to at least the actions for the timeframe using the machine learning system, the grammar corresponding to a help case; and
when the grammar is identified, retrieve corresponding help content for the help case and provide the corresponding help content.

12. The system of claim 11, wherein the machine learning system comprises a neural network.

13. The system of claim 11, wherein the user profile includes a user identifier and information about the user with respect to level of expertise, position, department, group, course, or geographic location or region.

14. The system of claim 11, wherein the activity is with respect to a productivity application.

15. The system of claim 11, wherein the activity is with respect to any active application as identified by an operating system.

16. The system of claim 11, wherein when the grammar corresponding to the help case is not identified with a sufficient confidence, the instructions direct the system to provide an indication that a help case was not identified.

17. A computer-readable storage medium comprising instructions that, when executed, cause a system to:
receive a user profile and actions for a timeframe, each action comprising an activity and timing;
identify a grammar that captures action semantics and sequences in which they are executed that is similar to at least the actions for the timeframe, the grammar corresponding to a help case; and
when the grammar is identified, retrieve corresponding help content for the help case and provide the corresponding help content.

18. The medium of claim 17, further comprising instructions to:
manage the help content for help cases.

19. The medium of claim 18, wherein one or more help content of the help content for help cases is determined from usage and stored in an index that at least indicates location of the help content and a topic of the help content.

20. The medium of claim 18, further comprising instructions to:
retrieve the help content from a help content resource, an Internet resource, a video platform with tagged content, a gig economy service, or a service providing help content.
